(19) United States
(12) Patent Application Publication
(10) Pub. No.: US 2016/0185015 A1
(43) Pub. Date: Jun. 30, 2016

(54) AUTOMATIC INSIDE-MOLD COLORING METHOD FOR STITCHES ON COVER OF MOLDED BASEBALL OR SOFTBALL

(71) Applicant: SHYI-MING Chen, Kaohsiung City (TW)

(72) Inventor: SHYI-MING Chen, Kaohsiung City (TW)

(21) Appl. No.: 14/583,262

(22) Filed: Dec. 26, 2014

(51) Int. Cl. B29C 37/00

(52) U.S. Cl. CPC B29C 37/0032; B29K 2075/00

(57) ABSTRACT

An automatic inside mold coloring method for stitches on a cover of a molded baseball or softball includes steps of: forming a ball core; placing a fiber layer around the ball core, infusing a liquid Polyurethane material into the fiber layer; attaching and aligning a masking jig onto inner side of the ball cover mold having multiple stitch-shape grooves to expose stitch-shape grooves while covering the rest of inner side of the ball cover mold; applying or spraying a coloring material onto said masking jig to fill the coloring material in the stitch-shape grooves; removing the masking jig from the ball cover mold; placing the ball core inside the ball cover mold and then in a metal mold holder; heating up the ball cover mold to cure the ball core; and removing a finished ball from the ball cover mold and the metal mold holder.

### BACKGROUND OF THE INVENTION

1. Field of the Invention

The present invention relates to a coloring method for stitches on the cover of a molded ball, and in particular to an automatic inside-mold coloring method for stitches on the cover of a molded baseball or softball, which can be realized through using indented stitch-shape grooves on the inner sides of a ball cover mold and a corresponding masking jig, such that in the process of forming the ball cover, the stitches on the ball cover is formed and colored integrally and automatically from inside the ball cover mold, thereby achieving fully integrated and long-lasting colored stitches of the ball in play, reducing production processes, increasing production speed, and decreasing the cost for coloring the stitches.

2. The Prior Arts

Conventionally, a baseball or softball is formed of a ball core and a ball cover. The ball core is formed of cork, cork and rubber mixture, plastic resins, or polyurethane (PU); while the ball cover is either (1) formed of cowhide leather, PU-coated split leather, and synthetic leather, such that it is hand-stitched to form a finished ball, or (2) the ball cover is mold-formed by two corresponding figure-8 shape ball cover mold pieces with the ball core enclosed in the ball cover to form an integral and complete ball. The method of producing such a cover-molded baseball or softball is described in detail in US patent numbers: U.S. Pat. No. 8,652,285, U.S. Pat. No. 8,342,832, and U.S. Pat. No. 8,535,470 issued to the same inventor under this application, and their contents are incorporated herein in its entirety for reference.

However, in the latter case of mold-formed ball cover, another step has to be performed to put color on the stitches of the ball cover. Yet, the problem is that, coloring the stitches can only be performed externally on to the molded stitch grooves of the finished ball, by way of a masking jig to paint over the stitches of the finished ball. The binding power of such externally applied coloring is very weak due to the thinness of coloring material thereby applied, and the lack of integrated bondage between coloring material and the finished surface of the molded ball. Consequently, the color put on the stitches in this way will fade or wear off when repeatedly impacted by baseball bat or moistened by water. The color fade or wear off could cause aesthetic concern in appearance and give the user a bad impression.

For the reasons mentioned above, the conventional design and production of a baseball or softball is not quite satisfactory, and it leaves much room for improvement.

### SUMMARY OF THE INVENTION

In view of the problems and limitations of the conventional molded baseball or softball, the present invention provides an automatic inside-mold coloring method for stitches on the cover of a molded baseball or softball, to effectively overcome the shortcomings of the conventional molded baseball or softball featuring the externally painted or dyed stitches after the ball has been finished and released from the ball mold.

A major objective of the present invention is to provide an automatic inside-mold coloring method for stitches on the cover of a molded baseball or softball.

The automatic inside-mold coloring method for stitches on the cover of a molded baseball or softball includes the following steps:

1. Forming a ball core.

2. Placing a fiber layer serving as a base of a consistent thickness around the ball core, then infusing a liquid Polyurethane (PU) material into and impregnating the fiber layer.

3. Attaching and aligning a masking jig onto an inner side of a ball cover mold having multiple stitch-shape grooves, with the masking jig having notches configured to expose said stitch-shape grooves on said inner side of the ball cover mold, while covering the rest of the inner side of the ball cover mold.

4. Using hands to apply or using a spraying tool to spray a coloring material on the masking jig to fill the coloring material in the stitch-shape grooves of the ball cover mold with the rest of the inner side of the ball cover mold shielded by the masking jig.

5. Removing the masking jig from the ball cover mold.

6. Placing the Polyurethane-soaked ball core inside the ball cover mold, and then putting the ball cover mold encased with the soaked ball core into a metal mold holder for the ball core to tightly engage with the ball cover mold.

7. Heating up the ball cover mold, and curing the PU-impregnated fiber layer around the ball core inside the ball cover mold at approximately 70° C. for 2 hours.

8. Removing a finished ball having two figure-8 shape rows of bulged stitches formed integrally with the coloring material thereon from the ball cover mold and the metal mold holder.

In the step 2 above, the fiber layer is porous and made of pile, felt, natural or synthetic fibers, natural or synthetic wound yarns, natural or synthetic non-woven cloth, or natural or synthetic woven cloth. The fiber layer is attached around the ball core, and then it is infused with Polyurethane.

In step 3 above, the masking jig having notches configured to expose the stitch-shape grooves while covering the rest of the inner side of the ball cover mold, is made of metal or plastics.

In step 4 above, the coloring material applied or sprayed onto the masking jig can be made of liquid polyurethane (PU) or other applicable dyeing material of a specific color.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is a flowchart of an automatic inside-mold coloring method for stitches on the cover of a molded baseball or softball according to the present invention;

FIG. 2 is a cross-sectional view of a baseball or softball made by the automatic inside-mold coloring method of FIG. 1;

FIG. 3(a) is an inner side view of a ball cover mold having stitch-shape grooves utilized in the automatic inside-mold coloring method of FIG. 1;

FIG. 3(b) is a top view of a masking jig having notches utilized in the automatic inside-mold coloring method of FIG. 1;

FIG. 4 is a schematic diagram of a ball core, a ball cover mold of two corresponding ball cover mold pieces utilized in the automatic inside-mold coloring method of FIG. 1;

FIG. 5 is a schematic diagram of a ball core, a ball cover mold, and a metal mold holder utilized in the automatic inside-mold coloring method of FIG. 1;

FIG. 6 is a top view of the metal mold holder in FIG. 5 when holding therein the ball core encased in the ball cover mold; and

FIG. 7 is a cross-sectional view of the metal mold holder in FIG. 5 when holding therein the ball core encased in the ball cover mold.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

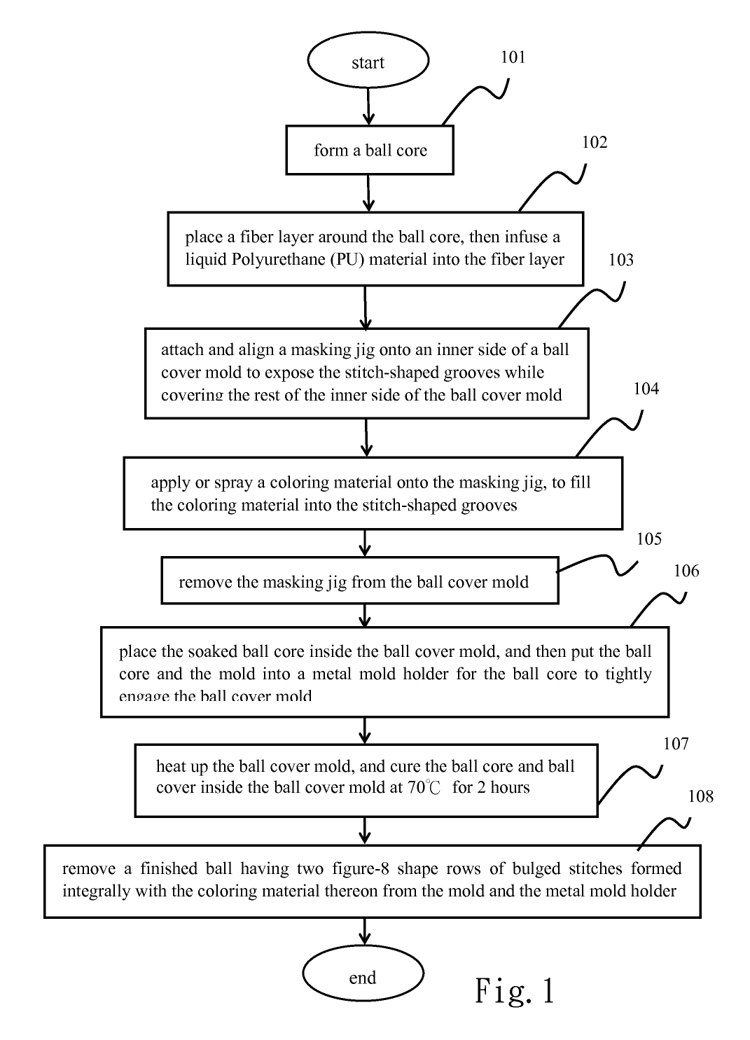

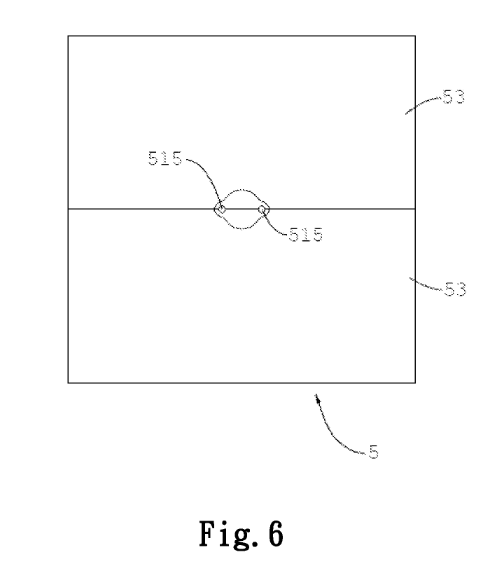

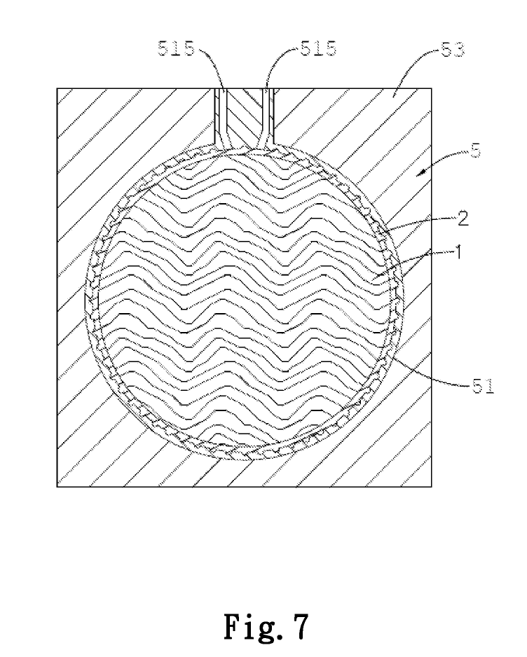

Refer to FIGS. 1 to 7 for detailed descriptions of an automatic inside-mold coloring method for stitches on the cover of a molded baseball or softball according to the present invention. Firstly, as shown in FIG. 1, the automatic inside-mold coloring method for stitches on the cover of a baseball or softball according to the present invention comprises the following steps:

1. Forming a ball core (step 101).

2. Placing a fiber layer serving as a base of consistent thickness around the ball core, then infusing a liquid Polyurethane material into and fully impregnating the fiber layer (step 102).

3. Attaching and aligning a masking jig onto an inner side of a ball cover mold having multiple stitch-shape grooves, with the masking jig having notches configured to expose the stitch-shape grooves on the inner side of the ball cover mold, while covering the rest of the inner side of the ball cover mold (step 103).

4. Using hands to apply or using a spraying tool to spray a coloring material on the masking jig to fill the coloring material in the stitch-shape grooves of the ball cover mold with the rest of the inner side of the ball cover mold shielded by the masking jig (step 104).

5. Removing the masking jig from the ball cover mold (step 105).

6. Placing the Polyurethane-soaked ball core inside the ball cover mold, and then putting the ball cover mold encased with the soaked ball core into a metal mold holder for the ball core to tightly engage with the ball cover mold (step 106).

7. Heating up the ball cover mold, and curing the PU-impregnated fiber layer around the ball core inside ball cover mold at approximately 70° C. for 2 hours (step 107).

8. Removing a finished ball having two figure-8 shape rows of bulged stitches formed integrally with the coloring material thereon from the ball cover mold and the metal mold holder (step 108).

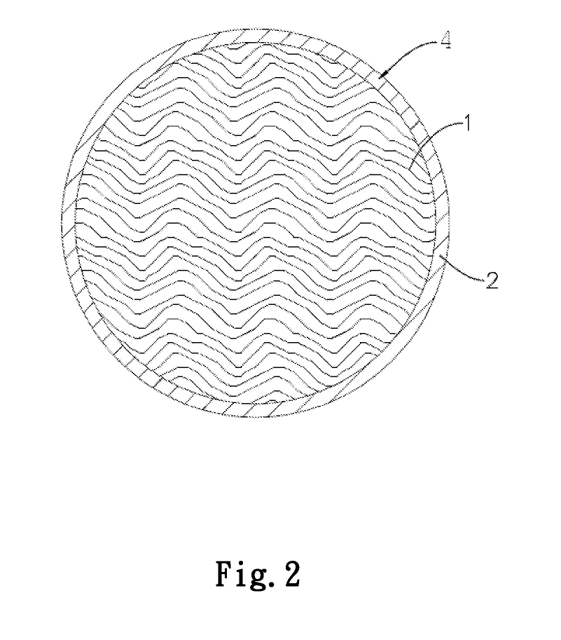

Then, refer to FIG. 2 for a cross-sectional view of a molded baseball or softball made by the foregoing automatic inside-mold coloring method for stitches on the cover of a molded baseball or softball. As shown in FIG. 2, the independently formed ball core 1 is one of the conventional ball cores used commonly in a regulation baseball and softball, that is made of Polyurethane, rubber, cork, cork and rubber mixture, composite material, or wool yarns wound in multiple layers.

The fiber layer 2 around the ball core 1 is porous or is full of pores when the fiber layer is yarn-wound, so as to quickly absorb and get fully impregnated with the liquid Polyurethane. This even fiber layer 2 plays an important role in centering the ball core inside the figure-8 shape ball cover mold and transforming itself, embedded in the Polyurethane, into an even thickness of the ball cover after the Polyurethane has been cured.

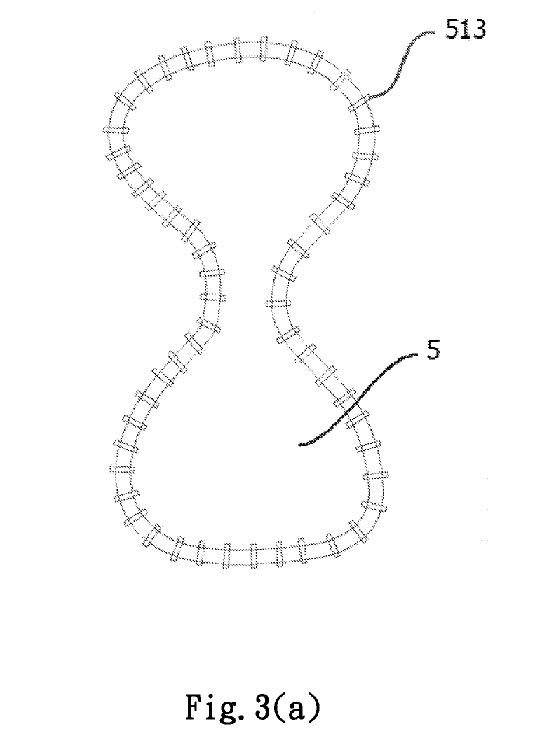

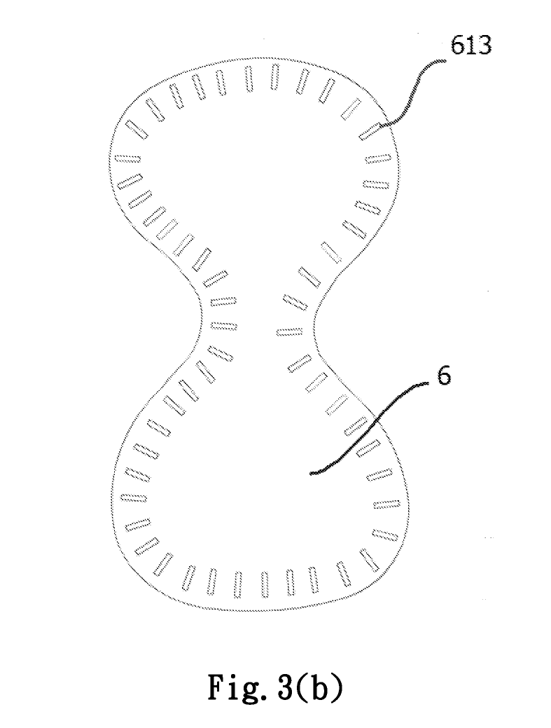

Refer to FIG. 3(a) for an inner side view of a ball cover mold having stitch-shape grooves utilized in the foregoing automatic inside-mold coloring method. As shown in FIG. 3(a), the inner side of a ball cover mold 5 is provided with a plurality of stitch-shape grooves 513 on the outer perimeter.

Also, refer to FIG. 3(b) for a top view of a masking jig having notches utilized in the foregoing automatic inside-mold coloring method. As shown in FIG. 3(b), a masking jig 6 is provided with a plurality of notches 613 on the outer perimeter corresponding to the plurality of stitch-shape grooves 513 on the inner side of the ball cover mold 5. To apply the coloring material, the masking jig 6 is firmly attached and aligned on the inner side of the ball cover mold 5, such that the plurality of notches 613 engage the plurality of stitch-shape grooves 513 on the inner side of the ball cover mold 5. When coloring material is applied or sprayed onto the masking jig 6, the coloring material will get into the stitch-shape grooves 513, while the rest of the inner side of the ball cover mold 5 is shielded from the coloring material by the masking jig 6. As such, during heating and curing, in the formation of the ball cover, the coloring material is transferred onto and formed integrally with the fiber layer 2, such that the bulged stitches are dyed with the color of the coloring material.

In the present embodiment, the coloring material is liquid Polyurethane (PU) of red color (that is the same material used in the ball cover, which can be of either the same color or a specific color), while the masking jig is made of metal or plastics, but the present invention is not limited to this.

In the present embodiment, the fiber layer is a single piece, and it is padded, laminated, or wound.

Also, in the present embodiment, the number of stitch-shape grooves 513 on the inner side of the ball cover mold 5 is 108, while the number of corresponding notches 613 on the masking jig 6 is also 108. As such, the number of the stitch-shape grooves on the inner side of the ball cover mold is the same as number of the notches on the masking jig.

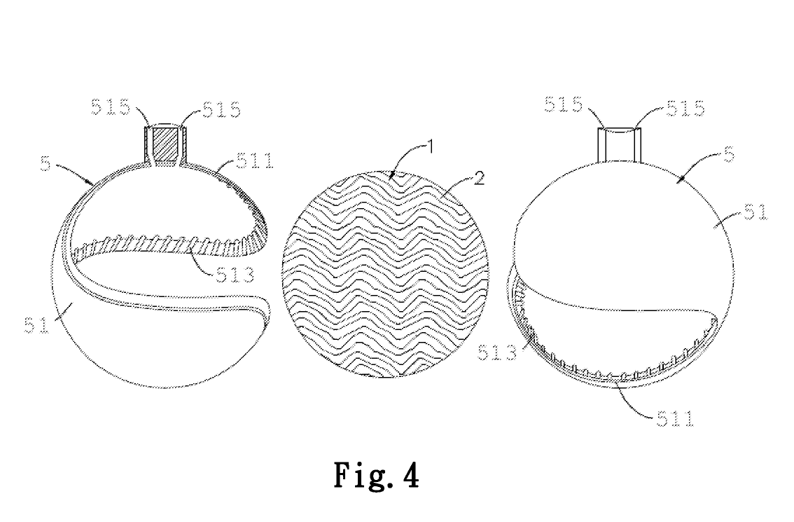

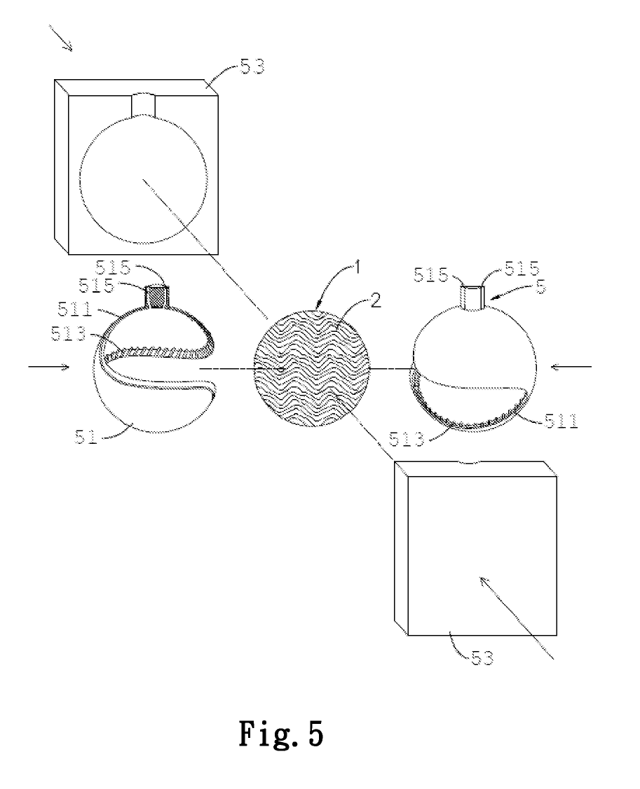

Refer to FIGS. 4 to 7, that show the soaked ball core 1 placed in the ball cover mold 5 (FIG. 4). The mated ball cover mold 5 is then placed in a metal mold holder 53 (FIG. 5) to be heated at approximately 70° C. for two hours to cure the Polyurethane-soaked, fiber-embedded part (fiber layer) of the ball core and transform it into a ball cover 4. In the present embodiment, the ball cover mold 5 consists of two figure-8 shape ball cover mold pieces 51, which are made of a soft or flexible material and in a shape of a clamshell and fit together to form the cover of a ball core. Also, a metal mold holder 53 is provided to allow the two figure-8 shape ball cover mold pieces 51 to stay tightly engaged in the heating and curing process. After the two figure-8 shape ball cover mold pieces 51 join together, the mated ball cover mold 5 is placed inside the metal mold holder 53 (as shown in FIGS. 5, 6 and 7). Also, after the ball cover mold 5 is heated to get the Polyurethane-soaked, fiber-embedded part (fiber layer) of the ball core cured, a finished ball is shape and colored by the two figure-8 shape ball cover mold pieces 51 (as shown in FIGS. 5, 6 and 7).

In the present embodiment, two small overflow spouts 515 are each set and positioned in between the abutting edges 511 of the two figure-8 shape ball cover mold pieces 51. During the heating and curing process, trapped air and excess Polyurethane liquid are exhausted through these overflow spouts 515 (as shown in FIGS. 4, 5, 6 and 7).

In the present invention, the masking jig can be replaced by an automated robotic arm or a dispensing machine to fill the coloring material individually and internally into each of the multiple stitch-shape grooves of the ball cover mold, in achieving the same automatic inside-mold coloring purpose.

In addition, the ball cover mold 5 is not restricted to be formed by two figure-8 shape ball cover mold pieces 51, it can also be constructed using two joining hemispherical mold pieces.

In the present invention, the stitch-coloring is pre-built or applied beforehand on the inner side of the ball cover mold as opposed to the conventionally well known practice of painting or dyeing on the surface of a finished, molded ball.

Moreover, the coloring material transferred off the stitch-shape groove of the ball cover mold is stuck to the fiber-embedded polyurethane material, and is cured and transformed into a ball cover inside the ball cover mold, thereby establishing a simultaneous and complete integration between the coloring material and the polyurethane-formed cover of the finished ball.

The major difference between the present invention and the conventional molded baseball or softball is that, the coloring of stitch-shape grooves in the present invention is done from inside the figure-8 shape ball cover mold piece 51, instead of from outside the finished ball cover 4 as done in the conventional molded baseball or softball. In addition, in the present invention, the coloring of stitch-shape grooves 513 is done during the heating and curing process. In contrast, in the conventional baseball or softball, the coloring of the stitch-shape grooves 513 is done after the heating and curing process, thus requiring an additional step. Further, the present invention has the advantages that the quality of the stitch coloring is improved, so that color of the stitches will not fade or wear off as caused by repeated batting impacts or contact with water and moisture.

Furthermore, another important advantage of the present invention is that, in the conventional method of coloring stitches on a molded baseball cover, about 216 stitches have to be colored for a baseball. Even for a skilled worker, about only 50 baseballs can be colored daily. However, in the present invention, several times that number of baseballs can be prepared and produced at the same time, by firmly attaching the masking jig having notches onto the inner side of each ball cover mold, and after applying the coloring material, then remove the masking jig and place the ball core and ball cover mold into a metal ball holder, to be heated in a large electric oven. In this approach, several dozens of baseballs each having colored stitches thereon can be produced automatically and simultaneously, thus saving production time and production cost significantly. Therefore, the present invention is able to achieve the objective not anticipated by the conventional molded baseball production method, such that the present case does have patent value.

Summing up the above and in conclusion, in the present invention, an automatic inside-mold coloring method for stitches on the cover of a molded baseball or softball is disclosed, which can be realized through using indented stitch-shape grooves on the inner side of a ball cover mold and corresponding masking jig having matching notches, such that in the process of forming the ball cover, the stitches on the ball cover is formed and colored integrally and automatically, hereby reducing production processes, increasing production speed, decreasing the cost for coloring stitches, while improving quality of the stitch coloring on the ball cover.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements, which are within the scope of the appended claims.

What is claimed is:

1. An automatic inside-mold coloring method for stitches on a cover of a molded baseball or softball, comprising steps of:
forming a ball core;
placing a fiber layer serving as a base of a consistent thickness around the ball core, then infusing liquid Polyurethane (PU) material into and impregnating said fiber layer ;
attaching and aligning a masking jig onto an inner side of a ball cover mold having multiple stitch-shape grooves, with said masking jig having notches configured to expose said stitch-shape grooves on said inner side of said ball cover mold while covering the rest of said inner side of said ball cover mold;
using hands to apply or using a spraying tool to spray a coloring material on said masking jig to fill said coloring material in said stitch-shape grooves of said ball cover mold with the rest of said inner side of said ball cover mold shielded by said masking jig;
removing said masking jig from said ball cover mold;
placing said Polyurethane-soaked ball core inside said ball cover mold, and then putting said ball cover mold encased with said soaked ball core into a metal mold holder for said ball core to tightly engage with said ball cover mold;
heating up said ball cover mold, and curing said Polyurethane-impregnated fiber layer around said ball core inside said ball cover mold at 70° C. for 2 hours; and
removing a finished ball having two figure-8 shape rows of bulged stitches formed integrally with said coloring material thereon from said ball cover mold and said metal mold holder.

2. The automatic inside-mold coloring method for stitches on a cover of a molded baseball or softball as claimed in claim 1, wherein stitch-coloring is pre-built or applied beforehand on said inner side of said ball cover mold as opposed to conventional practice of dyeing on a surface of a finished, molded ball.

3. The automatic inside-mold coloring method for stitches on a cover of a molded baseball or softball as claimed in claim 1, wherein said coloring material transferred off said stitch-shape groove of said ball cover mold is stuck to a fiber-embedded polyurethane material, and is cured and transformed into said ball cover inside said ball cover mold, thereby establishing a simultaneous and complete integration between said coloring material and a polyurethane-formed cover of said molded baseball or softball.

4. The automatic inside-mold coloring method for stitches on a cover of a molded baseball or softball as claimed in claim 1, wherein said masking jig is made of metal or plastics.

5. The automatic inside-mold coloring method for stitches on a cover of a molded baseball or softball as claimed in claim 4, wherein an automated robotic arm or a dispensing machine is used to replace said masking jig, to fill said coloring material individually and internally into each of said multiple stitch-shape grooves of said ball cover mold, in achieving same automatic inside mold coloring purpose.

6. The automatic inside-mold coloring method for stitches on a cover of a molded baseball or softball as claimed in claim 1, wherein said coloring material is liquid Polyurethane (PU) or other applicable coloring material of a specific color.

7. The automatic inside-mold coloring method for stitches on a cover of a molded baseball or softball as claimed in claim 1, wherein number of said stitch-shape grooves on said ball cover mold is same as number of said stitch-shape notches on said masking jig.

8. The automatic inside-mold coloring method for stitches on a cover of a molded baseball or softball as claimed in claim 1, wherein said ball core is used as a regulation baseball or softball core, and is made of Polyurethane, rubber, cork, cork and rubber mixture, composite material, or wool yarns wound in a plurality of layers.

9. The automatic inside-mold coloring method for stitches on a cover of a molded baseball or softball as claimed in claim 1, wherein said fiber layer is porous and made of pile, felt, natural or synthetic fibers, natural or synthetic wound yarns, natural or synthetic non-woven cloth, natural or synthetic woven cloth.

10. The automatic inside-mold coloring method for stitches on a cover of a molded baseball or softball as claimed in claim 9, wherein said fiber layer is a single piece, and it is padded, laminated, or wound.

11. The automatic inside-mold coloring method for stitches on a cover of a molded baseball or softball as claimed in claim 9, wherein said fiber layer is attached around said ball core, and then it is infused with Polyurethane.

12. The automatic inside-mold coloring method for stitches on a cover of a molded baseball or softball as claimed in claim 1, wherein said ball cover mold comprises two figure-8 shape ball cover mold pieces, which are made of a soft or flexible material and in a shape of a clamshell.
